(19) United States
(12) Patent Application Publication
(10) Pub. No.: US 2013/0290304 A1
(43) Pub. Date: Oct. 31, 2013

(54) SYSTEM AND METHOD FOR SEPARATING DOCUMENTS

(71) Applicant: ESTSOFT CORP., Seoul (KR)

(72) Inventor: Kun-Young SON, Seoul (KR)

(73) Assignee: ESTsoft Corp., Seoul (KR)

(21) Appl. No.: 13/868,082

(22) Filed: Apr. 22, 2013

(30) Foreign Application Priority Data
Apr. 25, 2012 (KR) 10-2012-0043404

(51) Int. Cl. G06F 17/30

(52) U.S. Cl. CPC G06F 17/30979
USPC 707/722

(57) ABSTRACT

A system for separating documents is disclosed. The system includes a multidimensional index creating module and a document separation criterion calculating module. The multidimensional index creating module calculates a multidimensional index for each documental material by calculating a plurality of document characteristic indexes from content information about individual documental materials contained in a primary document search result obtained in response to a search query received from a user device. The document separation criterion calculating module calculates a document separation criterion on the basis of both user preference information regarding at least one specific documental material selected from the documental materials contained in the primary document search result and the multidimensional index for the selected specific documental material. A secondary document search result is selected and provided according to the calculated document separation criterion among the documental materials contained in the primary document search result.

### BACKGROUND OF THE INVENTION

1. Field of the Invention

The present invention relates to a document search service technology using a communication network such as Internet and, more particularly, to a document separation system and method capable of providing a high-quality secondary search result for documents by predicting user preference with regard to documents found through a primary search.

2. Description of the Related Art

With information and communication technologies today advanced dramatically, a great variety of information about various fields is offered to users via data communication networks. Particularly, nowadays some information selecting techniques have been developed in order to offer more exact high-quality information to users. Thus, users are able to search for desired information through access to a search server.

Meanwhile, the rapid growth of communication technology and computing technology effectively reduces the time required for sharing information because various real-time search results can be provided. However, information uploaded on the web actually includes a lot of low-grade information, so that users become have a burden to review too much information so as to obtain high-quality information.

Recently, in order to provide first high-quality information to users, a technique to evaluate ranks of documental materials according to replies or ratings of some users with regard to such documental materials has been used. However, since this technique is based on evaluation of some users, search results are just provided uniformly to most users. Furthermore, since a search service operator should collect users' evaluation and thereby determine ranks of documents one by one with regard to all documental materials on the web, this search system is quite inefficient.

### BRIEF SUMMARY OF THE INVENTION

Accordingly, the present invention is to address the above-mentioned problems and/or disadvantages and to offer at least the advantages described below.

An aspect of the present invention is to provide a document separation system and method that not only can selectively offer a high-quality search result for documents with predicted user preference, but also can maximize the efficiency of a search system.

According to one aspect of the present invention, provided is a system for separating documents. The system includes a multidimensional index creating module configured to calculate a multidimensional index for each documental material by calculating a plurality of document characteristic indexes from content information about individual documental materials contained in a primary document search result obtained in response to a search query received from a user device; and a document separation criterion calculating module configured to calculate a document separation criterion on the basis of both user preference information regarding at least one specific documental material selected from the documental materials contained in the primary document search result and the multidimensional index for the selected specific documental material, wherein a secondary document search result is selected and provided according to the calculated document separation criterion among the documental materials contained in the primary document search result.

The system may further include an evaluation module configured to verify the document separation criterion calculated by the document separation criterion calculating module, based on the probability that the selected specific documental material having the user preference is contained in the secondary document search result.

The document separation criterion calculating module may be further configured to calculate the document separation criterion through a regression analysis algorithm or a conditional analysis algorithm.

According to another aspect of the present invention, the document separation system may be unified into a search server.

According to still another aspect of the present invention, provided is a method for separating documents. The method includes steps of creating a multidimensional index for each documental material by calculating a plurality of document characteristic indexes from content information about individual documental materials contained in a primary document search result obtained in response to a search query received from a user device; calculating a document separation criterion on the basis of both user preference information regarding at least one specific documental material selected from the documental materials contained in the primary document search result and the multidimensional index for the selected specific documental material; and providing a secondary document search result selected according to the calculated document separation criterion among the documental materials contained in the primary document search result.

The method may further include step of, after the step of calculating the document separation criterion, verifying the document separation criterion calculated by the document separation criterion calculating module, based on the probability that the selected specific documental material having the user preference is contained in the secondary document search result.

In the method, the step of calculating the document separation criterion may include calculating the document separation criterion through a regression analysis algorithm or a conditional analysis algorithm.

According to yet another aspect of the present invention, provided is a computer-readable recording medium having thereon a program for executing the document separation method recited above.

According to the document separation system and method of this invention, when a user who desires to search for a document through a search server selects at least one preferred or non-preferred document among documents contained in a primary document search result, the system analyzes the characteristics of documents including the selected document, separates specific documents, predicted to be preferred or non-preferred, from others, and then provides them as a secondary document search result. Thus, a user can easily obtain his or her desired high-quality documental materials.

Additionally, the document separation system and method of this invention may simply remove advertising or harmful documental materials from a document search result, so that a user can obtain more exact high-quality information in comparison with a conventional search service.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

FIG. 1 is a schematic diagram illustrating a network connection of a document separation system in accordance with an embodiment of the present invention.

FIG. 2 is a block diagram illustrating the configuration of a document separation system in accordance with an embodiment of the present invention.

FIG. 3 is a block diagram illustrating a multidimensional index DB in accordance with an embodiment of the present invention.

FIG. 4 is a flow diagram illustrating a document separation method performed between a user device, a search server and a document separation system in accordance with an embodiment of the present invention.

### DETAILED DESCRIPTION OF THE INVENTION

Exemplary embodiments of the present invention will now be described more fully with reference to the accompanying drawings. This invention may, however, be embodied in many different forms and should not be construed as limited to the exemplary embodiments set forth herein.

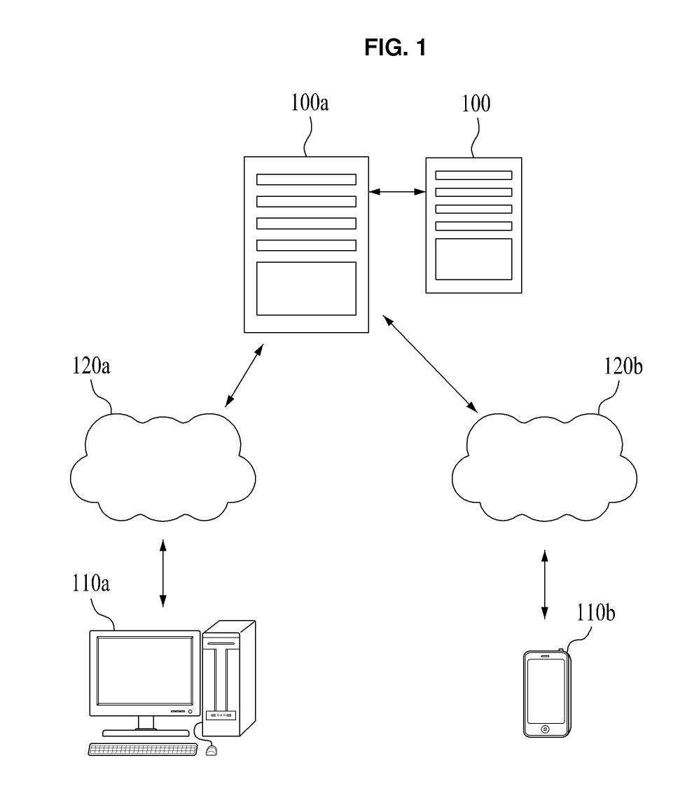

FIG. 1 is a schematic diagram illustrating a network connection of a document separation system in accordance with an embodiment of the present invention.

Referring to FIG. 1, each of user devices 110a and 110b accesses a search server 100a having a document separation system 100 through a wired or wireless communication network 120a or 120b and performs a search process. Namely, users enter keywords of their seeking document into the respective user devices 110a and 110b, which transmit them as search queries to the search server 100a. Then the search server 100a performs a search for documents on the basis of the search queries and returns search results to the user devices 110a and 110b. Particularly, the search server 100a can provide a document search result that the document separation system 100 creates based on predicted user preference. The document separation system 100 may be unified into the search server 100a that provides a web search service, or alternatively be constructed as a separate system which is physically apart from but communicates with the search server 100a through a certain communication network.

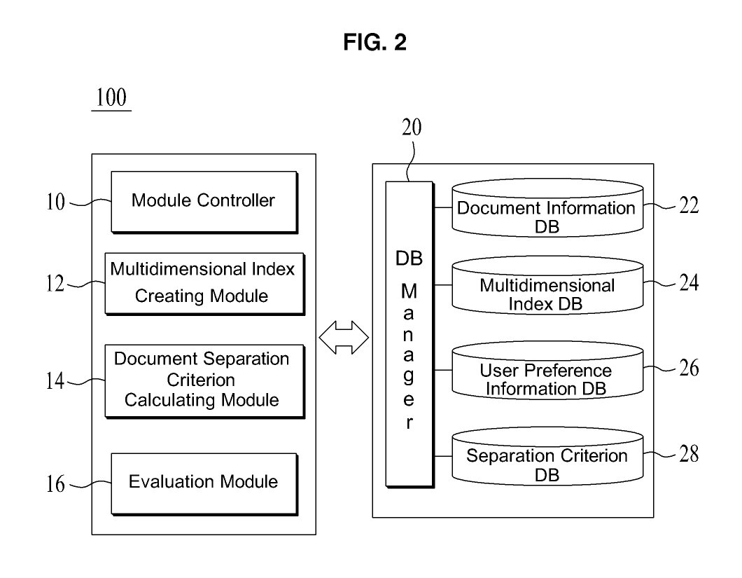

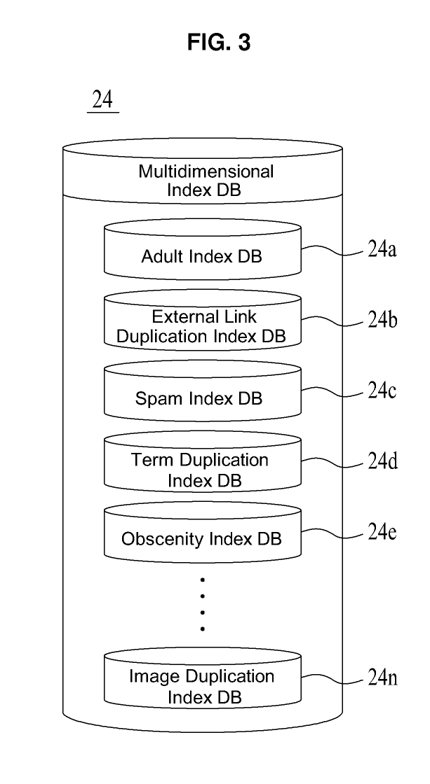

Now, a detailed configuration of the search separation system will be described with reference to FIGS. 2 and 3.

FIG. 2 is a block diagram illustrating the configuration of a document separation system in accordance with an embodiment of the present invention, and FIG. 3 is a block diagram illustrating a multidimensional index DB in accordance with an embodiment of the present invention.

As shown in FIG. 2, the document separation system 100 may include a multidimensional index creating module 12 and a document separation criterion calculating module 14, and may further include an evaluation module 16. All of the multidimensional index creating module 12, the document separation criterion calculating module 14 and the evaluation module 16 are controlled by a module controller 10. Particularly, if the document separation system 100 is unified into the search server 100a, the module controller 10 may suitably control the respective modules 12, 14 and 16 in response to instructions of the search server 100a. Although not illustrated in FIG. 2, the document separation system 100 may also include a certain communication module capable of communicating with the search server 100a when constructed at a place separated apart from the search server 100a.

Additionally, the document separation system 100 may include a document information DB 22, a multidimensional index DB 24, a user preference information DB 26, and a separation criterion DB 28, all of which are controlled by a database manager 20.

The document information DB 22 is a database that contains document information about a great variety of documental materials such as news, books, literature, and the like. The document information DB 22 may store identifiers of individual documents, such as URL (a uniform resource locator which indicates the location and kind of a particular information resource distributed in a computer network), to identify each document, and also store any kind of information about the contents of individual documents. Furthermore, the document information DB 22 may store multidimensional index information, as document characteristic indexes for respective documents, created by the multidimensional index creating module 12. A service operator may collect various documental materials on the Internet by utilizing a search engine and periodically update document information about individual documental materials.

The multidimensional index DB 24 is a database that contains criteria for calculating multidimensional indexes from the contents of individual documental materials. For example, as shown in FIG. 3, the multidimensional index DB 24 may include an adult index DB 24a also referred to as adult_score DB, an external link duplication index DB 24b also referred to as channelbodylink_score DB, a spam index DB 24c also referred to as channelspam_score DB, a term duplication index DB 24d also referred to as dup_term_score DB, an obscenity index DB 24e also referred to as eros_score DB, an image duplication index DB 24n also referred to as dup_image_score DB, and the like.

The term “multidimensional index” means various document characteristic indexes that distinguish respective documents from each other according to their contents. For example, the term “adult index” means an index calculated depending on how many adult prohibited words are contained in a document in comparison with normal words. The adult index DB 24a stores adult prohibited words selected by a service operator. The multidimensional index creating module 12 counts the total number of all words and the number of adult prohibited words contained in a document, and based on their ratio, creates an index ranging from zero to one.

The term “external link duplication index” is calculated depending on how many times a specific link is duplicated in documents. For example, if a certain blog has several (e.g., ten) documents, and if some (e.g., seven) of such documents contain a link to a particular website, the external link duplication index is created ranging from zero to one (e.g., 0.7). The external link duplication index DB 24b stores a specific criterion, predefined by a service operator, for determining the external link duplication index. Based on the predefined criterion, the multidimensional index creating module 12 calculates the external link duplication index of a document.

The term “spam index” is calculated by the multidimensional index creating module 12 according to a spam determination criterion stored in the spam index DB 24c. For example, depending on what percent of documents in a certain blog is determined as a spam according to the spam criterion, the spam index ranges from zero to one. The term “term duplication index” means an index calculated by counting the total number of terms contained in a document and the number of duplicated terms. The term “obscenity index” means an index calculated depending on how many obscene words, stored in the obscenity index DB 24e, are contained in a document. The term “image duplication index” means an index calculated depending on how many images are duplicated in a document.

In addition to document characteristic indexes exemplarily shown in FIG. 3, a service operator may further define other various document characteristic indexes according to the contents of documental materials, and the multidimensional index DB 24 may store various calculation criteria for calculating such document characteristic indexes.

The user preference information DB 26 is a database that contains user preference information received from the user device 110a and 110b. The user preference information means information that indicates user's likes or dislikes regarding each of documents received, as the result of a primary search, from the search server 100a.

The separation criterion DB 28 is a database that contains a specific equation or condition that is calculated depending on both user preference information inputted by a user through the document separation criterion calculating module 14 and multidimensional indexes for selected documents. Namely, the separation criterion DB 28 may store document separation criteria each of which is calculated for each user.

Now, a document separation method that uses the document separation system 100 and the search server 100a will be described in detail.

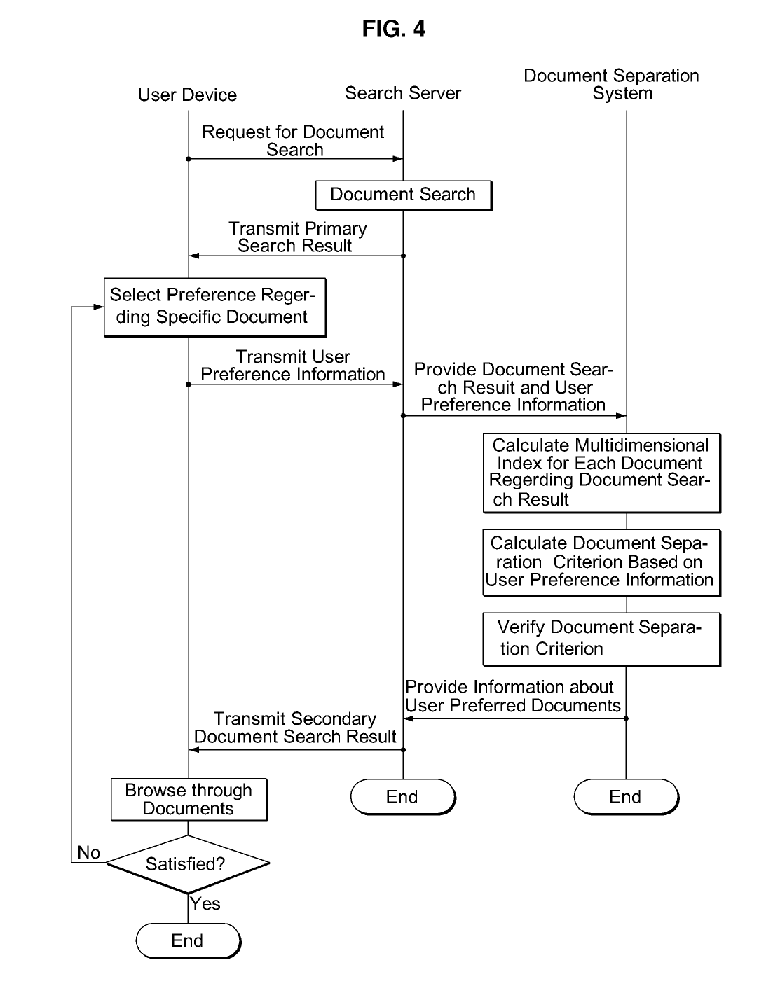

FIG. 4 is a flow diagram illustrating a document separation method performed between a user device, a search server and a document separation system in accordance with an embodiment of the present invention.

As shown in FIG. 4, at the outset, a user enters a search query corresponding to his or her seeking information into the user device 110a or 110b, which transmits user's search query to the search server 100a. Then the search server 100a performs a primary search based on user's search query through a suitable search engine and then returns a primary document search result to the user. At this time, the search server 100a may lead a user to select likes or dislikes regarding a specific interesting or uninteresting document among documents contained in the primary document search result. For example, the search server 100a may provide a webpage that not only shows URL links of documents arranged as the primary search result, but also allows a user to input his or her preference regarding at least one document through a click, check, or any other selection.

A user inputs his or her preference regarding only parts of documents contained in the primary search result without a need to select all documents. This preference information inputted by a user is transmitted to the search server 100a and the document separation system 100.

Meanwhile, before or after user preference of a specific document is received from a user, the document separation system 100 calculates a plurality of document characteristic indexes from the contents of individual documents with regard to all documents contained in the primary search result provided to a user by the search server 100a. Namely, the multidimensional index creating module 12 calculates a plurality of document characteristic indexes with regard to individual documents according to calculation criteria stored in the multidimensional index DB 24, and then the document characteristic indexes are stored in the document information DB 22.

Next, the document separation criterion calculating module 14 calculates document separation criteria for separating documents with predicted user preference from the others, based on both user preference information regarding selected documents contained in the primary search result and multidimensional indexes for the selected documents, and then the document separation criteria is stored in the separation criterion DB 28.

At this time, the document separation criterion calculating module 14 may calculate such document separation criteria through a regression analysis algorithm or a conditional analysis algorithm after analyzing both the user preference information regarding selected documents and the multidimensional indexes for the selected documents.

For example, it is supposed that the user preference information and the multidimensional indexes are calculated as shown in Table 1.

TABLE 1

| Document | User | Document Characteristic Index | | | | | |
|---|---|---|---|---|---|---|---|
| Identifier | Preference | A | B | C | D | E | F |
| DOC 1 | 1 | 0 | 0 | 1 | 0 | 0 | 1 |
| DOC 2 | 1 | 1 | 0 | 0 | 1 | 0 | 1 |
| DOC 3 | 0 | 0 | 0 | 0 | 0 | 0 | 0 |
| DOC 4 | 0 | 0 | 0 | 0.2 | 0 | 0.3 | 0 |

In this case, a specific document DOC 1 has vector values [1, 0, 0, 1, 0, 0, 1] that consist of user preference information and document characteristic indexes (i.e., multidimensional indexes). As seen intuitively from Table 1, it can be predicted that user's preferred documents (i.e., having a user preference value of “1”) are documents having “F” index of “1”. Therefore, by picking out only documents having “F” index of “1” from all documents contained in the primary search result, the document separation criterion can be obtained.

In order to calculate this criterion, the document separation criterion calculating module 14 may obtain the following equation by means of a regression analysis algorithm.

### [Calculation Equation Example by Regression Analysis Algorithm]

$$is\_spam = 0.0139 * spam\_score + 0.0019 * dup\_term \_score - 0.0001 * is\_best + 0 * channellately - 0.0001 * channelpperiod + 0 * totalcnt - 0 * post\_stay - 0.0003 * channeldup - 0 * imagecount + 0.3966 * dup\_image \_score + 0 * day\_posting \_max \_cnt - 0 * weekposting2\_cnt - 0 * haschanneltrain + 0.0001 * channelpperiod 2 + 0.0003 * channelspam - 0.1008$$

In this Equation, the term “is_spam” means a user preference factor. The above Equation is exemplary only and not to be considered as a limitation of this invention. Alternatively, other various equations may be used.

The document separation criterion calculating module 14 may calculate a document separation criterion on condition obtained by means of a conditional analysis algorithm, as follows.

### [Calculation Condition Example by Conditional Analysis Algorithm]

$$\begin{matrix}is spam = channelpperiod 2 <= 0.833 \text{:} \\ \vert spam\_score <= 0.357 \text{:} \\ \vert \vert channelspam <= 0.017 \text{:} \\ \vert \vert \vert imagecount <= 3.5 \text{:} LM 1 ( 60188 / 0 \% ) \\ \vert \vert \vert imagecount > 3.5 \text{:} \\ \vert \vert \vert \vert dup\_image \_score <= 0.192 \text{:} LM 2 ( 12550 / 0 \% ) \\ \vert \vert \vert \vert dup\_image \_score > 0.192 \text{:} \\ \vert \vert \vert \vert \vert dup\_image \_score <= 0.237 \text{:} LM 3 ( 1620 / 0 \% ) \\ \vert \vert \vert \vert \vert dup\_image \_score > 0.237 \text{:} \\ \text{\textbar} \vert \vert \vert \vert \vert imagecount <= 4.5 \text{:} \\ \vert \vert \vert \vert \vert \vert \vert channellately <= 1.008 \text{:} & \\ \vert \vert \vert \vert \vert \vert \vert \vert totalcnt <= 70 \text{:} \\ \vert \vert \vert \vert \vert \vert \vert \vert \vert channelpperiod <= 0.151 \text{:} LM 4 ( 228 / 11.686 \% ) \\ \vert \vert \vert \vert \vert \vert \vert \vert \vert channelpperiod > 0.151 \text{:} LM 5 ( 67 / 0 \% ) \\ \vert \vert \vert \vert \vert \vert \vert \vert totalcnt > \text{70} \text{:} & \\ \vert \vert \vert \vert \vert \vert \vert \vert \vert channeldup <= 0.2 \text{:} LM 6 ( 487 / 0 \% ) & \\ \vert \vert \vert \vert \vert \vert \vert \vert \vert channeldup > 0.2 \text{:} LM 7 ( 212 / 6.652 \% ) \\ \vert \vert \vert \vert \vert \vert \vert channellately > 1.008 \text{:} LM 8 ( 579 / 0 \% ) \\ \vert \vert \vert \vert \vert \vert imagecount > 4.5 \text{:} & \\ \vert \vert \vert \vert \vert \vert \vert dup\_image \_score <= 0.279 \text{:} LM 9 ( 354 / 0 \% ) & \\ \vert \vert \vert \vert \vert \vert \vert dup\_image \_score > 0.279 \text{:} & \\ \vert \vert \vert \vert \vert \vert \vert \vert dup\_image \_score <= 0.674 \text{:} LM 10 ( 19 / 34.948 \% ) \\ \vert \vert \vert \vert \vert \vert \vert \vert dup\_image \_score > 0.674 \text{:} LM 11 ( 72 / 0 \% ) \\ \vert \vert channelspam > 0.017 \text{:} \\ \vert \vert \vert channelspam <= 0.067 \text{:} & \\ \vert \vert \vert \vert dup\_image \_score <= 0.134 \text{:} LM 12 ( 11553 / 0 \% ) & \\ \vert \vert \vert \vert dup\_image \_score > 0.134 \text{:} & \\ \vert \vert \vert \vert \vert dup\_image \_score <= 0.192 \text{:} LM 13 ( 2681 / 0 \% ) & \\ \vert \vert \vert \vert \vert dup\_image \_score > 0.192 \text{:} \\ \vert \vert \vert \vert \vert \vert dup\_image \_score <= 0.237 \text{:} LM 14 ( 450 / 0 \% ) \\ \vert \vert \vert \vert \vert \vert dup\_image \_score > 0.237 \text{:} \\ \vert \vert \vert \vert \vert \vert \vert channeldup <= 0.226 \text{:} LM 15 ( 357 / 8.627 \% ) \\ \vert \vert \vert \vert \vert \vert \vert channeldup > 0.226 \text{:} LM 16 ( 146 / 0 \% ) \\ \vert \vert \vert channelspam > 0.067 \text{:} \\ \vert \vert \vert \vert channelspam <= 0.24 \text{:} & \\ \vert \vert \vert \vert \vert dup\_image \_score <= 0.134 \text{:} LM 17 ( 2437 / 0 \% ) & \\ \vert \vert \vert \vert \vert dup\_image \_score > 0.134 \text{:} & \\ \vert \vert \vert \vert \vert \vert dup\_image \_score <= 0.192 \text{:} LM 18 ( 497 / 0 \% ) & \\ \vert \vert \vert \vert \vert \vert dup\_image \_score > 0.192 \text{:} & \\ \begin{matrix}\vert \vert \vert \vert \vert \vert \vert totalcnt <= 74.5 \text{:} \\ \vert \vert \vert \vert \vert \vert \vert \vert channelspam <= 0.097 \text{:} LM 19 ( 39 / 0 \% ) \\ \vert \vert \vert \vert \vert \vert \vert \vert channelspam > 0.097 \text{:} LM 20 ( 39 / 17.351 \% ) \\ \vert \vert \vert \vert \vert \vert \vert totalcnt > 74.5 \text{:} LM 21 ( 114 / 0 \% )\end{matrix} & \\ \vert \vert \vert \vert channelspam < 0.24 \text{:} & \\ \vert \vert \vert \vert \vert channelspam <= 0.495 \text{:} LM 22 ( 261 / 12.557 \% ) & \\ \vert \vert \vert \vert \vert channelspam > 0.495 \text{:} LM 23 ( 521 / 0 \% ) & \\ \vert spam\_score > 0.357 \text{:} \\ \vert \vert spam\_score <= 0.798 \text{:} \\ \vert \vert \vert channelspam <= 0.051 \text{:} \\ \vert \vert \vert \vert dup\_term \_score <= 0.084 \text{:} LM 24 ( 3803 / 0 \% ) \\ \vert \vert \vert \vert dup\_term \_score > 0.084 \text{:} & \\ \vert \vert \vert \vert \vert dup\_term \_score <= 0.614 \text{:} LM 25 ( 726 / 0 \% ) \\ \vert \vert \vert \vert \vert \vert dup\_term \_score > 0.614 \text{:} & \\ \vert \vert \vert \vert \vert \vert \vert dup\_image \_score <= 0.134 \text{:} LM 26 ( 134 / 0 \% ) \\ \vert \vert \vert \vert \vert \vert \vert dup\_image \_score > 0.134 \text{:} LM 27 ( 91 / 17.358 \% ) ) \\ \vert \vert \vert channelspam > 0.051 : & \\ \vert \vert \vert \vert channelspam <= 0.494 \text{:} \\ \vert \vert \vert \vert \vert dup\_image \_score <= 0.134 \text{:} LM 28 ( 673 / 0 \% ) \\ \vert \vert \vert \vert \vert dup\_image \_score > 0.134 \text{:} \\ \vert \vert \vert \vert \vert \vert dup\_image \_score <= 0.192 \text{:} LM 29 ( 179 / 0 \% ) \\ \vert \vert \vert \vert \vert \vert dup\_image \_score > 0.192 \text{:} & \\ \vert \vert \vert \vert \vert \vert \vert dup\_image \_score <= 0.236 \text{:} LM 30 ( 34 / 0 \% ) \\ \vert \vert \vert \vert \vert \vert \vert dup\_image \_score > 0.236 \text{:} \\ \vert \vert \vert \vert \vert \vert \vert \vert weekposting 2 \_cnt <= 0.5 \text{:} \\ \vert \vert \vert \vert \vert \vert \vert \vert \vert dup\_image \_score <= 0.438 \text{:} LM 31 ( 11 / 0 \% ) & \\ \vert \vert \vert \vert \vert \vert \vert \vert \vert dup\_image \_score > 0.438 \text{:} LM 32 ( 5 / 0 \% ) \\ \vert \vert \vert \vert \vert \vert \vert \vert weekposting 2 \_cnt > 0.5 \text{:} LM 33 ( 15 / 0 \% ) \\ \vert \vert \vert \vert channelspam > 0.494 \text{:} LM 34 ( 272 / 0 \% ) \\ \vert \vert spam\_score > 0.798 \text{:} LM 35 ( 18819 / 0 \% ) \\ channelpperiod 2 > 0.833 \text{:} LM 36 ( 39078 / 0 \% ) & \end{matrix}$$

In short, the above condition calculated by a conditional analysis algorithm means that if the document characteristic index “channelpperiod2” is greater than 0.833, the user preference (is_spam) is “1”. If not greater, the user preference for individual one of documents is determined according to conditions of respective branches.

Based on the document separation criterion calculated as given above, a secondary document search result predicted to be preferred by a user can be obtained. The secondary document search result created by the document separation system 100 is provided to the user devices 110a and 110b via the search server 100a.

Meanwhile, after the document separation criterion is calculated by the document separation criterion calculating module 14, the document separation criterion may be verified by the evaluation module 16. For example, after a secondary document search result predicted to be preferred by a user is obtained according to the calculated document separation criterion, the evaluation module 16 may verify how many documents selected by user preference are contained in the secondary document search result. Then, based on the probability that the selected documents are included, the evaluation module 16 may instruct the document separation criterion calculating module 14 to calculate again a document separation criterion. If necessary, a user may also be instructed to further input user preference information. In this case, the document separation criterion calculating module 14 may calculate again a document separation criterion on the basis of new user preference information.

Additionally, a user who receives a secondary document search result may browse through documents contained in the secondary result. If satisfied with the secondary result, a user may stop searching. If not satisfied, a user may input again his or her preference regarding some documents contained in the primary search result or the second search result, and then the document separation method may be repeated.

The above-discussed document separation method may be implemented as program commands that can be executed by various computer means and written to a computer-readable recording medium. The computer-readable recording medium may include a program command, a data file, a data structure, etc. alone or in combination. The program commands written to the medium are designed or configured especially for the disclosure, or known to those skilled in computer software. Examples of the computer-readable recording medium include a hard disk, a CD-ROM, a DVD, and hardware devices configured especially to store and execute a program command, such as a ROM, a RAM, and a flash memory. The computer-readable recording medium can be distributed over a plurality of computer systems connected to a network so that processor-readable code is written thereto and executed therefrom in a decentralized manner. Programs, code, and code segments to realize the embodiments herein can be construed by one of ordinary skill in the art.

While this invention has been particularly shown and described with reference to an exemplary embodiment thereof, it will be understood by those skilled in the art that various changes in form and details may be made therein without departing from the spirit and scope of the invention as defined by the appended claims.

1. A system for separating documents, the system comprising:
a multidimensional index creating module configured to calculate a multidimensional index for each documental material by calculating a plurality of document characteristic indexes from content information about individual documental materials contained in a primary document search result obtained in response to a search query received from a user device; and
a document separation criterion calculating module configured to calculate a document separation criterion on the basis of both user preference information regarding at least one specific documental material selected from the documental materials contained in the primary document search result and the multidimensional index for the selected specific documental material,
wherein a secondary document search result is selected and provided according to the calculated document separation criterion among the documental materials contained in the primary document search result.

2. The system of claim 1, further comprising:
an evaluation module configured to verify the document separation criterion calculated by the document separation criterion calculating module, based on the probability that the selected specific documental material having the user preference is contained in the secondary document search result.

3. The system of claim 1, wherein the document separation criterion calculating module is further configured to calculate the document separation criterion through a regression analysis algorithm or a conditional analysis algorithm.

4. A search server comprising the document separation system recited in claim 1.

5. A method for separating documents, the method comprising:
creating a multidimensional index for each documental material by calculating a plurality of document characteristic indexes from content information about individual documental materials contained in a primary document search result obtained in response to a search query received from a user device;
calculating a document separation criterion on the basis of both user preference information regarding at least one specific documental material selected from the documental materials contained in the primary document search result and the multidimensional index for the selected specific documental material; and
providing a secondary document search result selected according to the calculated document separation criterion among the documental materials contained in the primary document search result.

6. The method of claim 5, further comprising:
after calculating the document separation criterion, verifying the document separation criterion calculated by the document separation criterion calculating module, based on the probability that the selected specific documental material having the user preference is contained in the secondary document search result.

7. The method of claim 5, wherein said calculating the document separation criterion includes calculating the document separation criterion through a regression analysis algorithm or a conditional analysis algorithm.

8. A computer-readable recording medium having thereon a program for executing the document separation method recited in claim 5.

9. A computer-readable recording medium having thereon a program for executing the document separation method recited in claim 6.

10. A computer-readable recording medium having thereon a program for executing the document separation method recited in claim 7.

11. A search server comprising the document separation system recited in claim 2.

12. A search server comprising the document separation system recited in claim 3.
